(19) United States
(12) Patent Application Publication
(10) Pub. No.: US 2017/0083217 A1
(43) Pub. Date: Mar. 23, 2017

(54) USER INTERFACE COMPONENTS LOAD TIME VISUALIZATION

(71) Applicant: Hewlett Packard Enterprise Development LP, Houston, TX (US)

(72) Inventors: Amichai Nitsan, Yehud (IL); Haim Shuvali, Yehud (IL); Inbar Shani, Yehud (IL)

(21) Appl. No.: 15/311,449

(22) PCT Filed: Sep. 8, 2014
(86) PCT No.: PCT/US2014/054478

§ 371 Date: Nov. 15, 2016

(51) Int. Cl. G06F 3/0484

(52) U.S. Cl. CPC G06F 3/04845; G06F 3/04842

(57) ABSTRACT

In one implementation, a system for user interface components load time visualization includes a load engine to monitor a load time of a number of elements of a user interface, a color engine to assign a color to each of the number of elements of the user interface based on the load time, and a compile engine to display a component color map of the user interface utilizing the color assigned to each of the number of elements.

### BACKGROUND

A number of tools can determine load times for a screen of a user interface. The load times for the window can include determining a load time of the complete window. A load time value can be calculated for the window and displayed to a user. The load time value can be a time that it takes for a complete window to completely load and be displayed to a user.

### BRIEF DESCRIPTION OF THE DRAWINGS

FIG. 1 illustrates a diagram of an example of a system for user interface components load time visualization according to the present disclosure.

FIG. 2 illustrates a diagram of an example computing device according to the present disclosure.

FIG. 3 illustrates a display for user interface components load time visualization according to the present disclosure.

FIG. 4 is a flow chart of an example of a method for user interface components load time visualization according to the present disclosure.

### DETAILED DESCRIPTION

A number of methods, systems, and computer readable medium for user interface components load time visualization are described herein. As used herein, a user interface components load time visualization includes a visual representation of load times for each element of a particular window and/or screen of a user interface. In some embodiments, the visual representation of load times for each element can include a component color map that is displayed on a particular window and/or screen of the user interface. As used herein, a component color map is a visual representation that utilizes a number of colors and/or patterns to display load time properties of a number of element and/or components of a user interface screen. In some embodiments, the component color map can be displayed on or over a snap shot of the user interface screen and/or window. As used herein, the elements include components of the user interface that load individually. For example, a first element can load on the user interface at a different rate (e.g., quantity of time) than a second element. In some embodiments, the elements of the user interface can include: images, menus, icons, tabs, and/or controls, among other components of the user interface.

In some embodiments, the elements of the user interface can be grouped together and a single color or pattern of the component color map can be used for the grouped elements. In these embodiments, the single color can be based on the greatest load time of the elements within the group. That is, if there are two elements in the group of elements, the load time of the element with the greatest load time can be utilized when determining a corresponding color for the group.

The component color map that is displayed on the window and/or screen of the user interface can be based on the load time of each element of the user interface. As used herein, the load time of each element includes a quantity of time that each individual element takes to be displayed on the user interface. For example, a window of the user interface can be selected and the load times of each element can be monitored from the selection of the window until each element is displayed on the user interface. In this example, each element can have a corresponding load time that can be used to generate the visual representation of load times for each of the elements.

A number of colors can be assigned to each of the elements based on the load times of each of the elements of a window and/or screen. The load times of each element for a particular window and/or screen can be used to generate a load time scale. In some embodiments, the load time scale can be an absolute scale. For example, the load time scale can be a scale from 0 seconds to 30 seconds. In some embodiments, the load time scale can be relative. For example, the load time scale can be a scale from 0 seconds to a greatest load time value for a particular screen and/or window of the user interface.

The load time scale can include the load times of each of the elements of the window and/or screen organized based on the corresponding load times. For example, the load time scale can be organized to include elements with a relatively larger load time towards a top end of the load time scale and elements with a relatively smaller load time towards the bottom end of the load time scale.

The load time scale can be utilized to generate a color scale. The color scale can correspond to the time scale. For example, a first load time (e.g., greatest load time, highest load time, etc.) can be assigned a first color (e.g., hot color, reddish color, red color, etc.) and a second load time (e.g., lowest load time, smallest load time, etc.) can be assigned a second color (e.g., cold color, bluish color, blue color, etc.). In this example, a number of colors can be assigned to each of the load times between the first load time and the second load time. In some embodiments, a color can be assigned to a particular range of load times. For example, the first color can be assigned to the first load time and any other elements that are within a particular load time range of the first element. In another example, a number of colors can represent a particular range of load time and not necessarily assigned to a greatest load time element and a lowest load time element. For example, a first color can be assigned to elements with a load time between 0 and 0.2 seconds and a second color can be assigned to elements with a load time between 0.2 and 0.4 seconds. In this example, additional colors can be assigned to ranges until the greatest load time element is within a range of an assigned color.

The color scale can be utilized to generate a component color map on a particular window and/or screen based on the load time and the color scale. In some embodiments, each of the elements displayed on the window and/or screen can be assigned a color based on a corresponding load time of each of the elements. The component color map can be displayed as a load time visualization to a user. The load time visualization can better represent the load time of each element compared to previous methods and systems for representing a load time of a window and/or screen of the user interface.

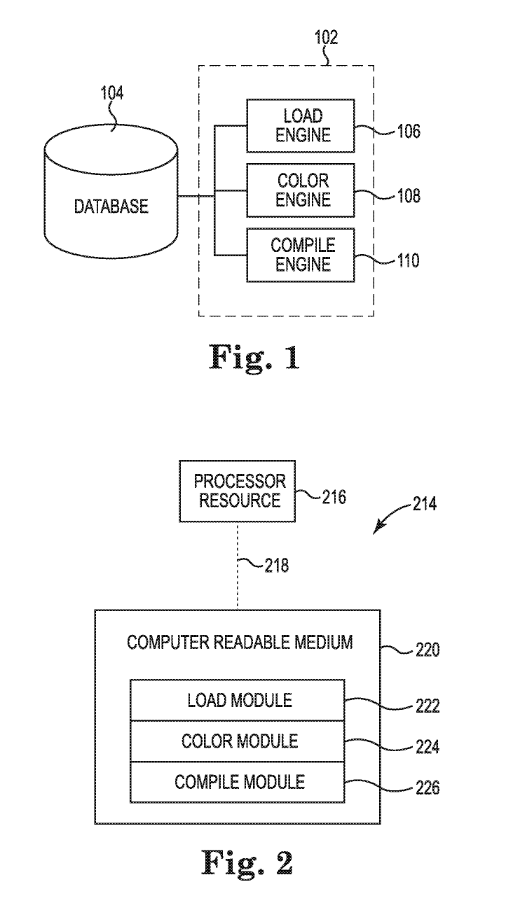

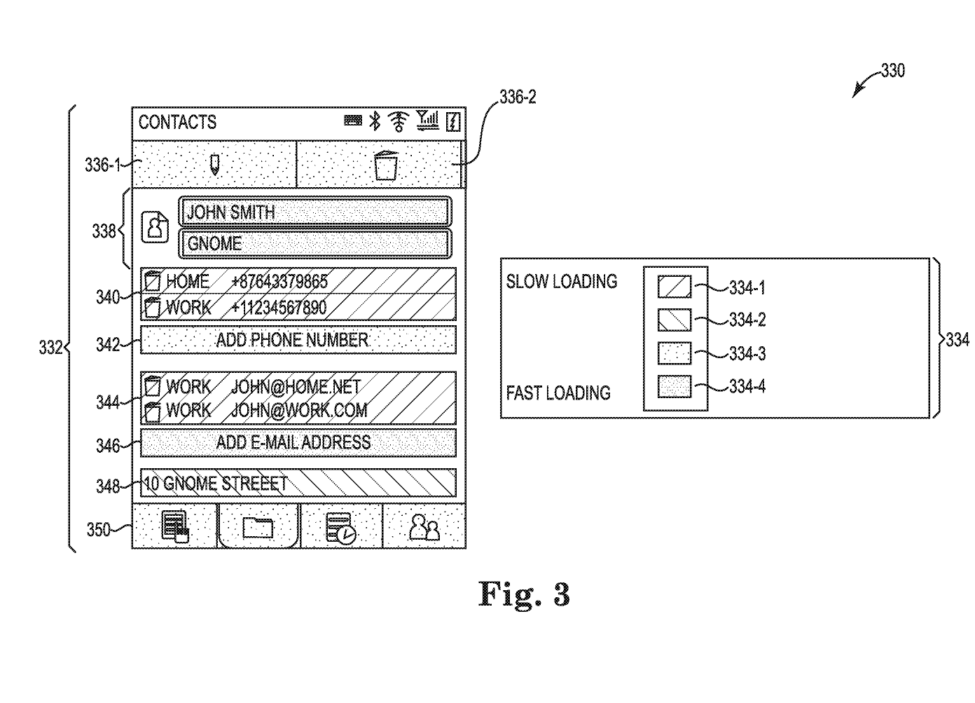

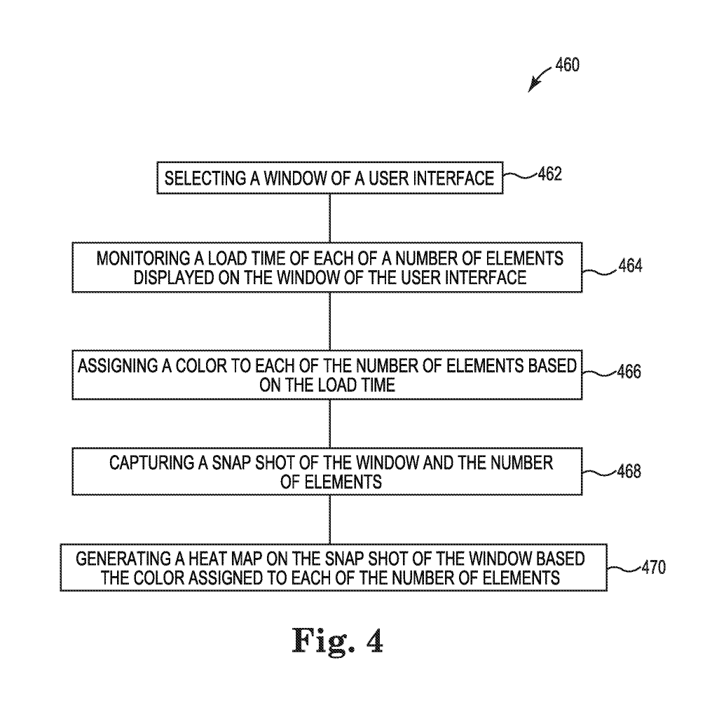

FIGS. 1 and 2 illustrate examples of system 100 and computing device 214 according to the present disclosure. FIG. 1 illustrates a diagram of an example of a system 100 for user interface components load time visualization according to the present disclosure. The system 100 can include a database 104, a user interface components load time visualization system 102, and/or a number of engines (e.g., load engine 106, color engine 108, compile engine 110). The user interface components load time visualization system 102 can be in communication with the database 104 via a communication link, and can include the number of engines (e.g., load engine 106, color engine 108, compile engine 110). The user interface components load time visualization system 102 can include additional or fewer engines that are illustrated to perform the various functions as will be described in further detail in connection with FIG. 3 and FIG. 4.

The number of engines (e.g., load engine 106, color engine 108, compile engine 110) can include a combination of hardware and programming, but at least hardware, that is configured to perform functions described herein (e.g., monitor a load time of a number of elements of a user interface, assign a color to each of the number of elements of the user interface based on the load time, display a component color map of the user interface utilizing the color assigned to each of the number of elements, etc.). The programming can include program instructions (e.g., software, firmware, etc.) stored in a memory resource (e.g., computer readable medium, machine readable medium, etc.) as well as hard-wired program (e.g., logic).

The load engine 106 can include hardware and/or a combination of hardware and programming, but at least hardware, to monitor a load time of a number of elements of a user interface. The load engine 106 can include hardware and/or a combination of hardware and programming, but at least hardware, to monitor each of a plurality of elements that are displayed on the user interface. In some embodiments, each of the number of elements are monitored separately to obtain a corresponding load time for each of the plurality of elements.

In some embodiments, the load engine 106 can monitor a load time of a number of elements of a user interface across a plurality of different devices. In these embodiments, the load engine 106 can take an average of each corresponding element to obtain an average load time of each of the number of elements of the user interface for the plurality of different devices.

The color engine 108 can include hardware and/or a combination of hardware and programming, but at least hardware, to assign a color to each of the number of elements of the user interface based on the load time. The color engine 108 can assign a color to each of the number of elements based on the load time of each corresponding element and based on a color scale. As described herein, the color scale can be generated using a load time scale. The load time scale can be based on a particular window and/or screen of the user interface. In some embodiments, the load time scale can be based on a greatest load time element and a lowest load time element of the particular window and/or screen. In these embodiments, the greatest and lowest load time elements can be displayed in a color that reflects which elements have a corresponding load time. In addition, the remaining elements can be assigned a color that reflects how close an element's load time is to the greatest load time element and/or how close an element's load time is to the lowest load time element.

The compile engine 110 can include hardware and/or a combination of hardware and programming, but at least hardware, to display a component color map of the user interface utilizing the color assigned to each of the number of elements. In some embodiments, the compile engine 110 can take a snap shot of the window and/or screen of the user interface. The screen shot, as used herein, is a still picture and/or image of a particular window and/or screen of the user interface.

In some embodiments, a component color map based on the load time of each of the elements displayed on the user interface can be placed over the snap shot of the window and/or screen of the user interface. For example, a color can be placed over each of the elements based on; the load time of the corresponding element, the load time scale, and/or the color scale. In some embodiments, the snap shot can include a number of other visual representations of the user interface. For example, the snap shot can include a wire frame representation of the user interface. In some embodiments, the snap shot can be a representation of the user interface screen and/or window with a particular resolution and/or aspect ratio.

FIG. 2 illustrates a diagram of an example computing device 214 according to the present disclosure. The computing device 214 can utilize software, hardware, firmware, and/or logic to perform functions described herein.

The computing device 214 can be any combination of hardware and program instructions configured to share information. The hardware, for example, can include a processing resource 216 and/or a memory resource 220 (e.g., computer-readable medium (ORM), machine readable medium (MRM), database, etc.). A processing resource 216, as used herein, can include any number of processors capable of executing instructions stored by a memory resource 220. Processing resource 216 may be implemented in a single device or distributed across multiple devices. The program instructions (e.g., computer readable instructions (CRI)) can include instructions stored on the memory resource 220 and executable by the processing resource 216 to implement a desired function (e.g., monitor a load time of each of a number of elements displayed on a window of a user interface, assign a color to each of the number of elements based on the load time, generate a component color map of the window based the color assigned to each of the number of elements, etc.).

The memory resource 220 can be in communication with a processing resource 216. A memory resource 220, as used herein, can include any number of memory components capable of storing instructions that can be executed by processing resource 216. Such memory resource 220 can be a non-transitory CRM or MRM. Memory resource 220 may be integrated in a single device or distributed across multiple devices. Further, memory resource 220 may be fully or partially integrated in the same device as processing resource 216 or it may be separate but accessible to that device and processing resource 216. Thus, it is noted that the computing device 214 may be implemented on a participant device, on a server device, on a collection of server devices, and/or a combination of the participant device and the server device.

The memory resource 220 can be in communication with the processing resource 216 via a communication link (e.g., a path) 218. The communication link 218 can be local or remote to a machine (e.g., a computing device) associated with the processing resource 216. Examples of a local communication link 218 can include an electronic bus internal to a machine (e.g., a computing device) where the memory resource 220 is one of volatile, non-volatile, fixed, and/or removable storage medium in communication with the processing resource 216 via the electronic bus.

A number of modules (e.g., load module 222, color module 224, compile module 226) can include CRI that when executed by the processing resource 216 can perform functions. The number of modules (e.g., load module 222, color module 224, compile module 226) can be sub-modules of other modules. For example, the color module 224 and the compile module 226 can be sub-modules and/or contained within the same computing device. In another example, the number of modules (e.g., load module 222, color module 224, compile module 226) can comprise individual modules at separate and distinct locations (e.g., CRM, etc.).

Each of the number of modules (e.g., load module 222, color module 224, compile module 226) can include instructions that when executed by the processing resource 216 can function as a corresponding engine as described herein. For example, the load module 222 can include instructions that when executed by the processing resource 216 can function as the load engine 106. In another example, the color module 224 can include instructions that when executed by the processing resource 216 can function as the color engine 108. In another example, the compile module 226 can include instructions that when executed by the processing resource 216 can function as the compile engine 110.

FIG. 3 illustrates a display 330 for user interface components load time visualization according to the present disclosure. The display 330 can be displayed on a physical user interface (e.g., monitor, touch screen, etc.) of a computing device. The display can include a screen and/or window of a user interface 332. As described herein, the load times of each element can be represented by a quantity of time it takes for a window and/or screen to load a corresponding element upon selection of the window and/or screen. For example, a load time of a phone number button 342 can be a quantity of time that it takes for the phone number button 342 to load upon selection of the tab 336-1.

The user interface can include a number of elements that are displayed on a window and/or screen. For example, the user interface 332 be a contact information window to add a contact to a contact list and can include elements that include, but are not limited to: tab 336-1, tab 336-2, name fields 338, phone number fields 340, add phone number button 342, email fields 344, add email button 346, address field 348, etc. In some embodiments, the user interface 332 can also include a number of navigational tabs 350 to navigate to other screens and/or windows of the user interface.

As described herein, the user interface 332 can be captured as a snap shot. That is, an image CaO be captured of the completely loaded user interface 332 (e.g., all elements of the user interface 332 are displayed). The snap shot of the user interface 332 can be utilized to generate a component color map of the user interface 332 based on the individual load times of each of the elements. That is, a color can be assigned to each element of the user interface and the color can be placed over the corresponding element of the snap shot to generate the component color map of the user interface 332.

In some embodiments, a plurality of different windows and/or screens of the user interface can be identified. In addition, each of the plurality of different windows and/or screens can be captured with a snap shot as described herein. Each of the plurality of different windows and/or screens can be individually monitored by monitoring each element of each corresponding window and/or screen to provide a component color map for each of the plurality of different windows and/or screens of the user interface.

In some embodiments, a load time monitor can be utilized to separately monitor a load time of each of the number of elements (e.g., tab 336-1, tab 336-2, name fields 338, phone number fields 340, add phone number button 342, email fields 344, add email button 346, address field 348, etc.). For example, the load time monitor can monitor the load time of tab 336-1 and separately monitor the load time of the phone number fields 340. In this example, the tab 336-1 and the number fields 340 are treated as separate and distinct elements of the user interface 332. The load time of each of the other elements can be monitored and stored for the screen and/or window of the user interface.

In some embodiments, a load time scale can be generated when the load times of each of the elements are stored by the load time monitor. The load time scale can include each of the load times corresponding to each of the elements organized in a scale from greatest load time to lowest load time. The load scale can include all of the elements for a particular window and/or screen of the user interface 332. That is, load times for elements of a different window and/or screen can be separated and utilized for a load scale that corresponds to the different window and/or screen of the user interface 332. A user can easily view the relative load times of each window and/or screen of the user interface 332 by including each element of a single window and/or screen of the user interface.

Having a user interface components load time visualization (e.g., component color map) for each window and/or screen of the user interface 332 can be advantageous over previous systems and methods since there can be elements of each window and/or screen of the user interface 332 that are more important to a particular user. For example, the name fields 338 can be more important to a particular user than the address field 348. In this example, it might not be important to the user if the address field 348 is relatively slower than the name fields 338.

The load time scale can be utilized to generate a color scale for the particular window and/or screen of the user interface 332. The color scale can be customized for the particular window and/or screen of the user interface 332. For example, a greatest load time of a first element can be assigned a first color (e.g., warm color, warm pattern, color 334-1 etc.) and a lowest load time of a second element can be assigned a second color (e.g., cool color, cool pattern, color 334-4, etc.). In this example, the remaining elements can be assigned a particular color that corresponds to the load time of each of the remaining elements based on how closely related the load time is to the greatest load time element and/or how closely related the load time is to the lowest load time element.

The display 330 can include a key 334 that can include a number of patterns and/or colors that represent elements of relatively fast loading (e.g., lower load time) and elements of relatively slow loading (e.g., greater load time). The key 334 can be based on the color scale that is generated based on the load times of each of the elements of the user interface 332. In some embodiments, the key 334 can utilize a warmer color to represent elements of relatively slow loading and a cooler color to represent elements of relatively fast loading. For example, the key 334 can include a red color for box 334-1, which can represent a relatively slow loading element such as the phone number element 340. In another example, the key 334 can include a blue color for box 334-4, which can represent a relatively fast loading element such as the name fields 338.

In some embodiments, the load time for each element of the user interface 332 can be an average load time for each element. In some embodiments, the average load time can be an average load time of each element loading on a particular device. For example, the window and/or screen of the user interface 332 can be loaded a plurality of times on the same computing device and an average (e.g., mean, medium, average, etc.) can be calculated for each element load time of the user interface 332 for the computing device. In some embodiments, the average load time of each element can be calculated for a plurality of different computing devices. For example, load times for each of the elements of the user interface 332 can be collected for a plurality of different computing devices. In this example, an average can be calculated for the load times of each of the elements of the user interface 332 for the plurality of different computing devices and the average can be utilized as the load time for each corresponding element.

In some embodiments, an ignore feature can be utilized to select and/or deselect elements of the user interface 332. For example, a user can select particular elements to ignore when the particular element is not important to the user. For example, if the address field 348 is not an important feature to a user, the user can select the address field 348 and the address field 348 can be ignored in the component color map determination. In some embodiments, the ignore feature can be utilized to ignore elements such as advertisements. In some cases, the advertisements that are displayed on a user interface 332 may not be important o a user and thus may not be considered if the load time of the advertisement is relatively slow. Thus, the load time of the ignored elements may not be considered in the load time scale or the color scale.

The display 330 can be advantageous over previous methods and systems by providing a component color map for each window and/or screen of the user interface 332 that includes a visual representation of relative load times for each element of the user interface 332. The component color map for each window and/or screen can be utilized to determine which elements of the user interface 332 are loading relatively faster or slower compared to other elements of the window and/or screen. This information can be useful to developers and engineers of the user interface 332 in determinations for allocating resources to particular elements of the user interface. In addition, the component color map can give an indication of an end user experience of the user interface window and/or screen.

FIG. 4 is a flow chart of an example of a method 460 for user interface components load time visualization according to the present disclosure. The method 460 can be performed by the system and/or computing device described herein. For example, the method 460 can be performed by the computing device 214 as referenced in FIG. 2.

At box 462 the method 460 can include selecting a window of a user interface. As described herein, the load times can be based on a quantity of time it takes for a particular element to load (e.g., displayed) upon selection of a particular window and/or screen of a user interface. Selecting the window can include selecting a particular tab and/or button that executes a new window and/or screen of the user interface.

At box 464 the method 460 can include monitoring a load time of each of a number of elements displayed on the window of the user interface. As described herein, each element (e.g., tabs, buttons, text boxes, etc.) can be monitored and a load time for each of the number of elements can be determined separately. Each individual load time can be utilized to generate a load time scale for the window and/or screen of the user interface. In addition, the load time scale can be utilized to generate a color scale that is based on the load time scale for the window and/or screen of the user interface.

At box 466 the method 460 can include assigning a color to each of the number of elements based on the load time. In some embodiments, the method 460 can include generating a color scheme based on the monitored load times of each of the number of elements. The color scheme can include a color scale that utilizes a particular color to represent a relative load time of a particular element.

Assigning a color to each of the number of elements can include assigning a first color to a highest load time element and a second color to a lowest load time element. In addition, each of the remaining elements can be assigned a color that is between the first color assigned to the highest load time element and the second color that is assigned to the lowest load time element. In some embodiments, a particular color can represent a range of load times (e.g., 0 to 0.1, 0.1 to 0.2, 0.2 to 0.3, etc.).

At box 468 the method 460 can include capturing a snap shot of the window and the number of elements. Capturing a snap shot of the window and/or screen of the number of elements can include capturing an image of the window of the user interface with all of the elements displayed on the user interface. The captured image can be utilized to overlay a component color map based on a color scale that is generated.

At box 470 the method 460 can include generating a component color map on the snap shot of the window based the color assigned to each of the number of elements. As described herein, the component color map can include a number of colors and/or patterns to represent a load time of a corresponding element of the user interface. Each element on the user interface can be represented by a corresponding color.

The method 460 can be advantageous over previous methods and systems by displaying a component color map for a particular window and/or screen of a user interface that can be used to easily identify elements of the window and/or screen of the user interface that might be taking a longer quantity of time to load. In addition, the method 460 can be utilized to generate a component color map of a particular window to determine a user experience of a particular window and/or screen of the user interface. For example, the component color map of a particular window can give a better representation of a user experience of the window compared to a value that represents an average load time of all of the elements and/or a value that represents a slowest element of the window. For example, even if a particular element has a relatively high load time, the particular element of the window may not be an important element to the user and therefore would not particularly inhibit a user's experience when utilizing the window of the user interface.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed is:

1. A system for user interface components load time visualization, comprising:
a load engine to monitor a load time of a number of elements of a user interface;
a color engine to assign a color to each of the number of elements of the user interface based on the load time; and
a compile engine to display a component color map of the user interface utilizing the color assigned to each of the number of elements.

2. The system of claim 1, wherein the number of elements of the user interface include displayed elements of a particular window of the user interface.

3. The system of claim 1, wherein each of the number of elements is assigned a load time.

4. The system of claim 1, wherein the load time is a quantity of time a particular element takes to be displayed on the user interface.

5. The system of claim 1, wherein the compile engine takes a snap shot of a particular window of the user interface that includes the number of elements.

6. The system of claim 1, wherein the component color map is placed on a visual representation of the particular window.

7. The system of claim 1, wherein each of the number of elements is displayed in the color assigned by the color engine to generate the component color map.

8. A non-transitory computer readable medium storing instructions executable by a processing resource to cause a controller to:
monitor a load time of each of a number of elements displayed on a window of a user interface;
assign a color to each of the number of elements based on the load time; and
generate a component color map of the window based the color assigned to each of the number of elements.

9. The medium of claim 8, comprising instructions to identify a plurality of different windows of the user interface and capture a snap shot of the plurality of different windows of the user interface.

10. The medium of claim 9, wherein the component color map is generated by taking a snap shot of the window and applying the assigned color to each of the number of elements displayed on the snap shot.

11. The medium of claim 9, wherein a first color is assigned to an element from the number of elements with a greatest load time and a second color is assigned to an element from the number of elements with a lowest load time.

12. A method for network tool synchronization, comprising:
selecting a window of a user interface;
monitoring a load time of each of a number of elements displayed on the window of the user interface;
assigning a color to each of the number of elements based on the load time;
capturing a snap shot of the window and the number of elements; and
generating a component color map on the snap shot of the window based the color assigned to each of the number of elements.

13. The method of claim 12, wherein selecting the window includes selecting an element from a different window of the user interface that executes instructions to display the window.

14. The method of claim 12, wherein assigning the color includes generating a color scheme based on the monitored load times of each of the number of elements.

15. The method of claim 14, wherein monitoring the load time includes monitoring a quantity of time between selecting the window and a corresponding element from
the number of elements being displayed on the user interface.
